(19) United States
(12) Patent Application Publication
(10) Pub. No.: US 2004/0202824 A1
(43) Pub. Date: Oct. 14, 2004

(54) Molded laminate and method for producing the same

(75) Inventors: Minoru Hayashi, Nagoya-shi (JP); Yoshiko Kato, Anjo-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/762,250

(22) Filed: Jan. 23, 2004

(30) Foreign Application Priority Data
Jan. 24, 2003 (JP) 2003-015896

(51) Int. Cl. B32B 3/00

(52) U.S. Cl. 428/174; 264/259

(57) ABSTRACT

A sheet-shaped molded laminate includes a laminated skin member including a decorative face, and a resin base material integrally injection molded on a face of the laminated skin member placed on an opposite side to the decorative face of the laminated skin member. The laminated skin member includes a foamed layer with a density equal to or greater than 0.04 g/cm³, a sheet-shaped decorative skin member bonded to one face of the foamed layer, and a sheet-shaped backing layer bonded to the other face of the foamed layer. Before the laminated skin member and the resin base material are integrally molded, an elastic modulus of the laminated skin member in a warping deformation preventive direction is equal to or smaller than 196N/25 mm (width of a test piece of the laminated skin member: 25 mm) with the laminated skin member being stretched by 33%.

This application is based on and claims priority under 35 U.S.C. § 119 with respect to Japanese Application No.2003-015896 filed on Jan. 24, 2003, the entire contents of which are incorporated herein by reference.

### FIELD OF THE INVENTION

The present invention generally relates to a molded laminate and method for producing the same. More particularly, the present invention pertains to a molded laminate which is used for an interior equipment such as a sunshade, a door trim, and a ceiling wall of a vehicle, building and the like.

### BACKGROUND OF THE INVENTION

A molded laminate used for a sunshade is generally formed by integrally bonding a glass fiber sheet, an urethane sheet and the like through the use of a hot press for forming a sheet-shaped base material, to which a decorative skin member is bonded through the use of the hot press via an adhesive that is applied to a surface of the sheet-shaped base material. The sunshade is arranged in a thin space of the ceiling wall and thus cannot be thicker.

Japanese Patent Laid-Open Publication No. 2000-343557 discloses an integrally molded product formed by bonding a decorative skin member to a front face of urethane foam layer with the density of 0.02 to 0.05 g/cm³, as well as bonding a sheet back face layer made of nonwoven fabric to a back face of the urethane foam layer, and further injection molding a base material on a face of the sheet back face layer that is placed opposite to the urethane foam layer side. According to the disclosed integrally molded product, even if a shape deformation is caused on the sheet back face layer, the shape deformation may be absorbed in the urethane form layer, thereby preventing the decorative skin member from creasing.

In addition, Japanese Patent No. 3237528 (Laid-Open Publication No. H10-24445) discloses an integral molding method for integrally molding a skin member and a core material by filling the molten resin as the core material into a mold cavity formed by the skin member and a mold after clamping the mold with the skin member interposed therein. According to the disclosed integral molding method, the resin pressure in the mold cavity is set between 686 and 1470N/cm² (i.e. approximately 70 to 150 kgf/cm²) during the injection filling and then retained between 19.6 and 490N/cm² (i.e. approximately 2 to 50 kgf/cm²). The deformation or warping of the integrally molded product is avoided without damaging the skin member. According to the above-mentioned disclosed techniques, however, the molded laminate used in a portion whose temperature is raised and thus the warping is likely to occur, such as a sunshade, is not mentioned.

Instead of using a hot press for producing the molded laminate for the sunshade, the producing method by injection molding has been developed recently. According to the injection molding, work improvement may be achieved and a manufacturing cost be reduced when compared to the hot press.

The molded laminate used for the sunshade is easy to warp by receiving the sunlight and thus the high rigidity against the high temperature is required for the molded laminate. Nevertheless, the sunshade is arranged within a thin space of the ceiling wall and thus improving the rigidity of the sunshade by thickening is limited.

The resin base material molded on the opposite face of the laminated skin member to the decorative face side is defined as offering the rigidity against the high temperature. However, the resin base material is possibly softened according to the conditions when the molded laminate is used. In this case, warping may be caused in the molded laminate used for the sunshade.

In order to avoid warping of the molded laminate, a strong reinforcing rib is desirable to be formed on the molded laminate. However, the sunshade is arranged within the thin space of the ceiling wall as mentioned above. In addition, a transparent glass plate is provided above the sunshade. Thus, even though the sunshade requires a high rigidity against the high temperature, the installation of the reinforcing rib is not possible in view of the space.

According to the aforementioned publications, a situation in which the molded laminate is used in a portion that receives the sunlight and thus the warping is likely to occur is not considered.

Thus, a need exists for a molded laminate and method for producing the same whereby warping is avoided or reduced while the molded laminate remains not thickened, especially when the molded laminate is used in a portion such as a sunshade whose temperature is easy to be raised.

### SUMMARY OF THE INVENTION

According to an aspect of the present invention, a sheet-shaped molded laminate having at least one of a concave portion and a convex portion includes a laminated skin member including a sheet-shaped lamination structure and a decorative face, and a resin base material integrally injection molded on a face of the laminated skin member placed on an opposite side to the decorative face of the laminated skin member. The laminated skin member includes a sheet-shaped foamed layer with a density equal to or greater than 0.04 g/cm³, a sheet-shaped decorative skin member bonded to one face of the foamed layer and including the decorative face, and a sheet-shaped backing layer bonded to the other face of the foamed layer. Before the laminated skin member and the resin base material are integrally molded, an elastic modulus of the laminated skin member in a warping deformation preventive direction of the molded laminate is equal to or smaller than 196N/25 mm (width of a test piece of the laminated skin member: 25 mm) with the laminated skin member being stretched by 33%.

According to another aspect of the present invention, a producing method of a molded laminate having at least one of a concave portion and a convex portion includes a first step for preparing a laminated skin member including a lamination structure formed by a sheet-shaped foamed layer, a sheet-shaped decorative skin member bonded to one face of the foamed layer and including a decorative face and a sheet-shaped backing layer bonded to the other face of the foamed layer. Further, the producing method of the molded laminate includes a second step for setting the laminated skin member in a cavity of an injection mold having a concave portion or a convex portion, and a third step for molding a resin base material on the backing layer side of the laminated skin member by injection molding of a resin in the cavity and at the same time, integrally bonding the backing layer of the laminated skin member and the resin base material. The foamed layer is set with a density equal to or greater than 0.04 g/cm³ in the first step. In addition, an elastic modulus of the laminated skin member in a warping deformation preventive direction of the molded lamination in the first step is set equal to or smaller than 196N/25 mm (width of a test piece of the laminated skin member: 25 mm) with the laminated skin member being stretched by 33%.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a plane view of a molded laminate used for a sunshade;

FIG. 2 is a perspective view illustrating vicinity of a sunroof device when a sunshade is partially open;

FIG. 3 is a side view of the molded laminate viewed from an arrow D of FIG. 1;

FIG. 4A is a cross-sectional view taken along a line A-A of FIG. 1;

FIG. 4B is a cross-sectional view taken along a line B-B of FIG. 1;

FIG. 4C is a cross-sectional view taken along a line C-C of FIG. 1;

FIG. 5 is a cross-sectional view of a laminated skin member before an injection molding is conducted;

FIG. 6 is a cross-sectional view of the molded laminate after a resin base material is integrally molded on the laminated skin member through the injection molding;

FIG. 7 is a cross-sectional view of an injection mold when the laminated skin member is set in a cavity of the injection mold; and

FIG. 8 is a perspective view illustrating a pattern how the laminated skin member is cut from a roll member.

### DETAILED DESCRIPTION OF THE INVENTION

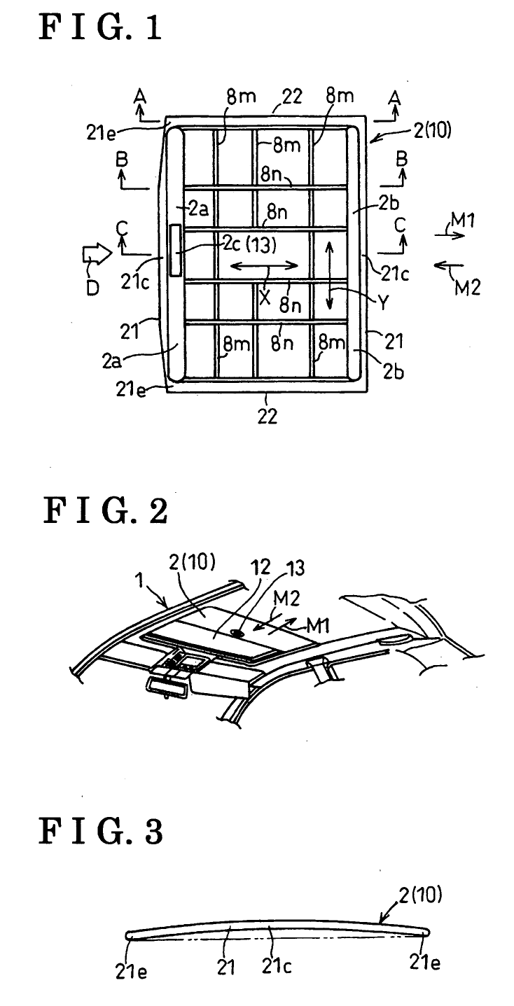

An embodiment of the present invention is explained referring to attached drawings. Here, the invention is employed in a sunshade provided at a sunroof device mounted on a ceiling of a movable member such as a vehicle. FIG. 1 is a plane view of a molded laminate 2 constituting a sunshade 10 when viewed from an upper side thereof. FIG. 2 is a perspective view of the partially-opened sunshade 10 of a sunroof device 1 mounted on the ceiling of the vehicle. The sunroof device 1 is to open or close an opening of the ceiling of the vehicle.

As shown in FIG. 2, the sunshade 10 is arranged below a transparent glass plate 12, which can open or close the ceiling opening, and thus receives the sunlight passing through the transparent glass plate 12. The sunshade 10 can be opened or closed in a direction of arrows M1 and M2 (vehicle longitudinal direction). The sunshade 10 can be opened or closed in the direction of the arrows M1 and M2 along with the transparent glass plate 12, which remains to close the ceiling opening, in response to a switch operation. The sunshade 10 can be also opened or closed along with the transparent glass plate 12 in the direction of the arrows M1 and M2 in response to the switch operation. A recess 13 is provided on a vehicle inner side of the sunshade 10 for manually opening or closing the sunshade 10. Both organic glass and inorganic glass may be acceptable as the transparent glass plate 12.

FIG. 3 is a side view of the molded laminate 2 shown in FIG. 1 when viewed from a direction of an arrow D. As shown in FIG. 3, the shape of the molded laminate 2 constituting the sunshade 10 is thin according to the present embodiment. At the same time, a center portion of the sunshade 10 is upwardly bulged into arched shape in section. Therefore, the molded laminate 2 is equipped with a reinforced structure by a shallow dome shape while maintaining the thin shape.

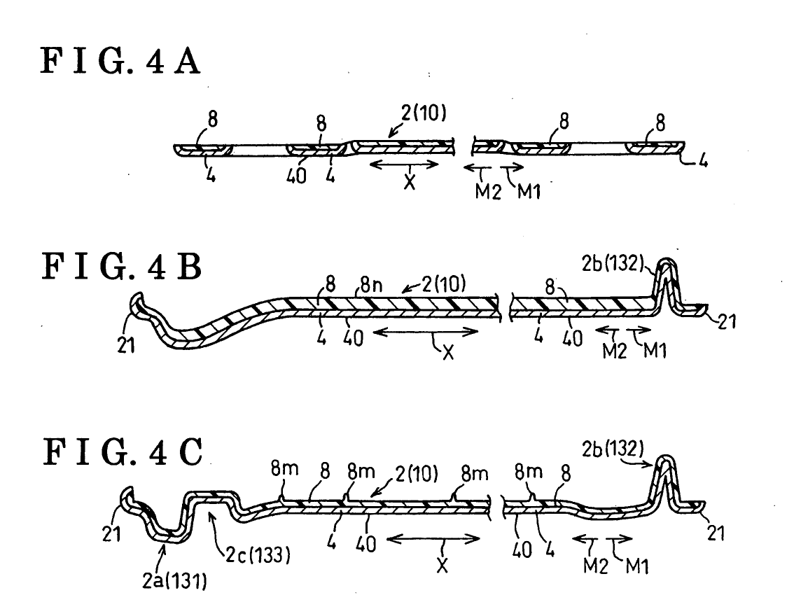

FIG. 4A is a cross-sectional view taken along a line A-A of FIG. 1. FIG. 4B is a cross-sectional view taken along a ling B-B of FIG. 1. FIG. 4C is a cross-sectional view taken along a line C-C of FIG. 1. As shown in FIGS. 4A to 4C, the thin molded laminate 2 includes reinforcing ribs 2a and 2b for preventing the molded laminate 2 from warping in an arrow Y direction in FIG. 1. In addition, the molded laminate 2 includes a concave portion 2c to which the recess 13 is attached. The reinforcing rib 2a is formed at a front edge portion of the molded laminate 2, i.e. leftward direction in FIG. 1, while the reinforcing rib 2b is formed at a rear edge portion of the molded laminate 2, i.e. rightward direction in FIG. 1. With these positions of the reinforcing ribs 2a and 2b, the installation performance of the molded laminate 2 may not be interfered.

As shown in FIG. 4C, the reinforcing rib 2a is molded by a concave mold 131 of the injection mold for transferring the reinforcing rib 2a. The reinforcing rib 2b is molded by a concave mold 132 of the injection mold for transferring the reinforcing rib 2b. The concave portion 2c of the molded laminate 2 is molded by a convex mold 133 of the injection mold for transferring the concave portion 2c.

According to the present embodiment, the direction of an arrow X of FIG. 1 indicates a warping deformation preventive direction of the molded laminate 2. The arrow Y of FIG. 1 indicates the crossing direction to the warping deformation preventive direction of the molded laminate 2.

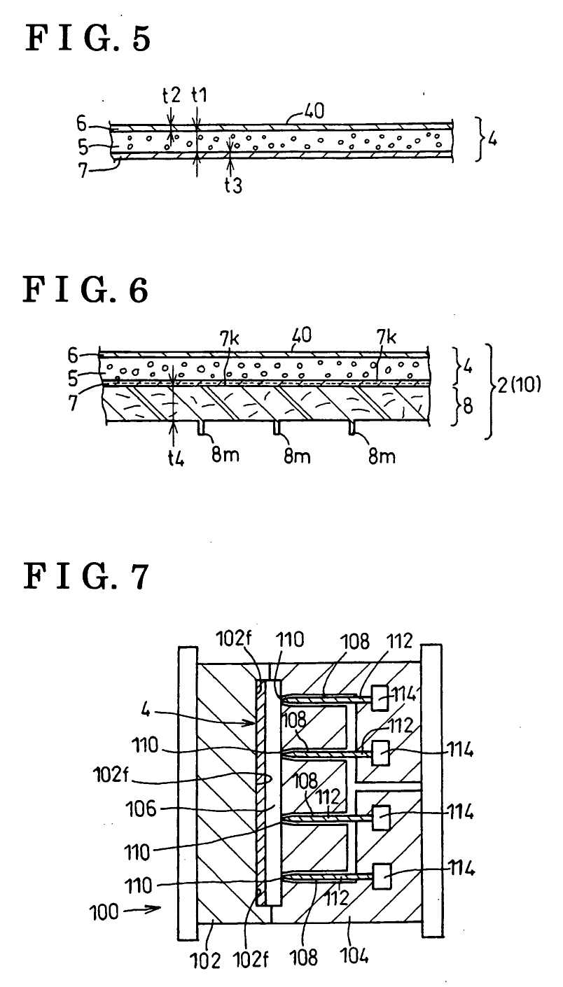

FIG. 5 is a cross-sectional view of a sheet-shaped laminated skin member 4 before the laminated skin member 4 is bonded to the molded laminate 2, i.e. before the laminated skin member 4 is injection molded. The laminated skin member 4 has a three-layer structure by laminating a sheet-shaped foamed layer 5 in which a plurality of pores are dispersed, a sheet-shaped decorative skin member 6 bonded to a front face (i.e. upper side in FIG. 5) of the foamed layer 5, and a sheet-shaped backing layer 7 bonded to a back face (i.e. lower side in FIG. 5) of the foamed layer 5.

A decorative face 40 placed on the front side of the decorative skin member 6 faces inside of the vehicle and thus viewed by an occupant. Therefore, the decorative face 40 is required to have a better appearance. The foamed layer 5 is formed by ether urethane foam, whose average thickness t1 is defined as 2.0 mm. The decorative skin member 6 is formed by fabric, whose average thickness t2 is defined as 0.8 mm. The backing layer 7 is formed by polyester nonwoven fabric, whose average thickness t3 is defined as 0.9 mm.

FIG. 6 is a cross-sectional view of the molded laminate 2 in which a sheet-shaped resin base material 8 is laminated on a back face (lower side in FIG. 6) of the laminated skin member 4, i.e. a cross-sectional view of the molded laminate 2 after the injection molding is performed. The resin base material 8 has rigidity against the high temperature. That is, the resin base material 8 is formed by a mixture of polycarbonate and acrylonitrile-ethylene propylene-terpolymer-styrene (PC/AES), whose average thickness is defined as 2.3 mm, and includes glass fiber as a strengthened fiber. The ratio of the glass fiber in the resin base material 8 is 20% by weight. Projecting ribs 8n extending in the vehicle longitudinal direction and projecting ribs 8m extending in the vehicle transverse direction are formed on a face of the resin base member 8, being placed opposite to the vehicle inner face thereof. Each height of the projecting rib 8m or 8n, i.e. a length in the vehicle vertical direction, is set relatively lower in order to mount the molded laminate 2 within a ceiling space of the vehicle.

As shown in FIG. 6, the molded laminate 2 constituting the sunshade 10 is formed by laminating the sheet-shaped laminated structural skin member 4 including the decorative face 40, and the resin base material 8 integrally molded on an opposite side to the decorative face 40 of the laminated skin member 4 through the injection molding. An average thickness t4 of the resin base material 8 is defined as 2.3 mm. The decorative face 40 of the laminated skin member 4 is facing the vehicle inner side and viewed by an occupant.

According to the present embodiment, the elastic modulus of the laminated skin member 4 (width of a test piece of the laminated skin member 4: 25 mm) in the warping deformation preventive direction of the molded laminate 2 (arrow X direction), in case that the laminated skin member 4 and the resin base material 8 are not yet integrally molded, is set equal to or smaller than 196N/25 mm, i.e., also set equal to or greater than 19.6N/25 mm with the laminated skin member 4 being stretched by 33%. Thus, the warping deformation of the molded laminate 2 is prevented.

A producing method of the molded laminate 2 according to the present embodiment is explained as follows. In a first process, the laminated skin member 4 as shown in FIG. 5 is prepared. The laminated skin member 4 includes the sheet-shaped foamed layer 5, the sheet-shaped decorative skin member 6 including the decorative face 40 bonded to the front face of the foamed layer 5, and the sheet-shaped backing layer 7 bonded to the back face of the foamed layer 5.

According to the laminated skin member 4 in the first process, the elastic modulus of the laminated skin member 4 is set equal to or smaller than 196N (approximately 20 kgf) in the warping deformation preventive direction of the molded laminate 2 at a time of the laminated skin member 4 being stretched by 33%. Therefore, the laminated skin member 4 has a predetermined flexibility in the warping deformation preventive direction before the injection molding is performed. In this case, one end of the test piece that is cut from the laminated skin member 4 (150 mm in length, 25 mm in width, and 4 mm in thickness with the length direction corresponding to the arrow X direction) is stretched in the length direction thereof at a tensile speed of 200 mm/min with the other end of the test piece being fixed. Then, the load at a time of the test piece being stretched by 33% is evaluated, which is defined as the elastic modulus under 33% of stretching. The 33% of stretching is provided by considering the situation in the injection molding conducted in the injection mold for forming the sunshade. In this stretching state, the laminated skin member 4 is stretched but not broken.

According to the present embodiment, in the first process, the sheet-shaped foamed layer 5 is set with the density equal to or greater than 0.04 g/cm³, and precisely, equal to or greater than 0.05 g/cm³. More specifically, the foamed layer 6 is set with the density between 0.057 and 0.063 g/m³. The backing layer 7 of the laminated skin member 4 prevents the resin forming the resin base material 8 from excessively penetrating through the laminated skin member 4. Thus, the backing layer 7 is set with the density equal to or greater than 100 g/m² in the first process. Specifically, the backing layer 7 is set with the density between 100 g/m² and 160 g/m².

According to the present embodiment, in the first process, i.e. in a state before the laminated skin member 4 and the resin base material 8 are integrally molded, the laminated skin member 4 has the anisotropy in the elastic modulus. That is, E1, which is defined as the elastic modulus of the laminated skin member 4 in the warping deformation preventive direction of the molded laminate 2 (arrow X direction) before the injection molding, is set lower than E2, which is defined as the elastic modulus of the laminated skin member 4 in the crossing direction to the warping deformation preventive direction (arrow Y direction) (i.e. E1<E2). Therefore, the elastic modulus E1 of the laminated skin member 4 is set relatively lower before the injection molding. In the same time, the elastic modulus E2 of the laminated skin member 4 is set relatively higher than the elastic modulus E1 before the injection molding.

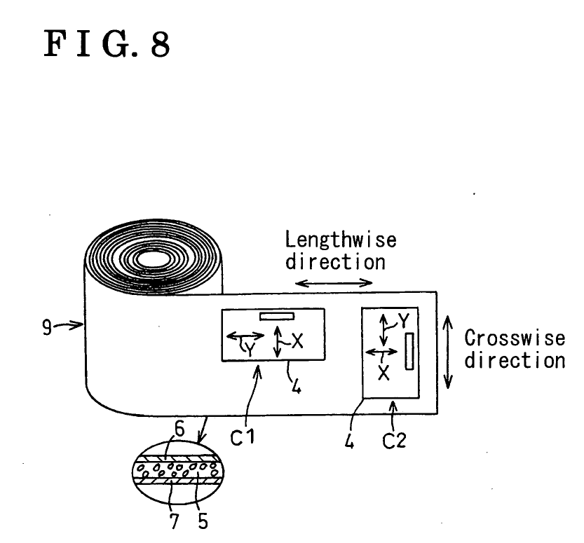

In the first process, a roll member 9 formed by the laminated skin member 4 being wound into a roll shape is used as shown in FIG. 8. That is, the laminated skin member 4 is prepared by appropriately cut from the roll member 9. Generally, the elastic modulus in the roll winding direction, which is defined as the lengthwise direction of the roll member 9, is higher. In addition, the elastic modulus in a crossing direction to the winding direction of the roll member 9, which is defined as the crosswise direction of the roll member 9, is lower. This may be caused by the influence in the manufacturing process of the roll member 9.

According to the present embodiment, as shown in a pattern C1 in FIG. 8, the laminated skin member 4 is cut from the roll member 9 such that the arrow X direction of the molded laminate 2 after the injection molding being performed corresponds to the crosswise direction of the roll member 9.

Then, the elastic modulus E1 of the laminated skin member 4 can be set relatively lower. At the same time, the elastic modulus E2 of the laminated skin member 4 can be set relatively higher. Whereas, when the laminated skin member 4 is cut from the roll member 9 such that the arrow X direction of the molded laminate 2 after the injection molding being performed corresponds to the lengthwise direction of the roll member 9 as shown in a pattern C2 in FIG. 8, the elastic modulus E1 of the laminated skin member 4 is set relatively higher. At the same time, the elastic modulus E2 of the laminated skin member 4 is set relatively lower, which is not desirable.

In the second process according to the present embodiment, the laminated skin member 4 cut from the roll member 9 in the pattern C1 is set in a cavity 106 of an injection mold 100 (shown in FIG. 7). In this case, the laminated skin member 4 is set such that the warping deformation preventive direction of the molded laminate 2 after the injection molding being performed corresponds to the crosswise direction of the roll member 9.

In the second process, the injection mold 100 is used as shown in FIG. 7. The injection mold 100 includes a vertically split mold formed by a first mold 102 and a second mold 104 constituting the cavity 106 for molding, a plurality of hot runners 108 connected to the cavity 106, a plurality of inlets 110 connected from the hot runners 108 to the cavity 106, a plurality of valve members 112 each functioning as an open/close member for opening/closing each inlet 110, and a plurality of driving portions 114 for opening/closing each valve member 112. The inlets 110 are formed with vertically and horizontally keeping a predetermined distance therebetween and connected to the cavity 106.

In the second process as shown in FIG. 7, the laminated skin member 4 is set in the cavity 106 of the injection mold 100. The laminated skin member 4 is positioned along a cavity face 102f of the first mold 102 of the injection mold 100 via a pin (not shown). Then, the laminated skin member 4 is set in the cavity 106 of the injection mold 100 such that the warping deformation preventive direction of the molded laminate 2 after the injection molding being performed corresponds to the crosswise direction of the roll member 9.

After setting the laminated skin member 4 in the aforementioned manner, molten resin (thermoplastic resin) is supplied to the hot runners 108 of the injection mold 100 by operating the injection-molding machine (not shown). Then, the molten resin is injection molded into the cavity 106 of the injection mold 100 via the inlets 110 and solidified. The resin includes the glass fiber as the strengthen fiber as mentioned above. The resin temperature is between 260 and 280 degrees in Celsius, the temperature of the injection mold 100 is between 50 and 70 degrees in Celsius, and the injection molding pressure is between 1.37 and 1.77KN/cm² as the target condition for the injection molding.

When the injection molding is conducted as mentioned above, the plurality of inlets 110 are not opened at the same time but opened in order from the lower side to the upper side in FIG. 7 in the injection mold 100. Then, the resin is input from the lower side to the upper side in the cavity 106. Alternatively, the inlets 110 may be opened in order from the upper side to the lower side in FIG. 7 in the injection mold 100. This may result in the reduced injection molding pressure and the reduced weld lines. According to the aforementioned injection molding, the resin base material 8 is molded on the backing layer 7 side of the laminated skin member 4. At the same time, the resin base material 8 is integrally adhered to the backing layer 7. In this case, the injection-molded resin penetrates through the backing layer 7, thereby forming a penetrating portion 7k (shown in FIG. 6). Since the injection-molded resin penetrates through the backing layer 7, the integral bonding ability between the laminated skin member 4 and the resin base material 8 is further increased.

In the first process as mentioned above, the foamed layer 5 is set with the density equal to or greater than 0.04 g/cm³. Precisely, the foamed layer 5 is set with the density equal to or greater than 0.05 g/cm³. Thus, the foamed layer 5 has the appropriate rigidity and is prevented from being excessively crushed by the injection molding pressure when the molten resin of the resin base material 8 is injection molded into the cavity 106 of the injection mold 100 in the third process. The required rigidity of the molded laminate 2 may be assured after the molding.

According to the present embodiment, the foamed layer 5 is slightly crushed by the injection molding pressure. Thus, the post-heating treatment (recovery treatment) is performed on the molded laminate 2 after the injection molding is performed by applying the infrared rays thereto for heating. The required rigidity of the foamed layer 5 is ensured by recovering the thickness thereof. Then, the foamed layer 5 has the substantially same density as that acquired before the injection molding. In addition, according to the present embodiment, the backing layer 7 is set with the appropriate density (weight) as mentioned above. Therefore, the bonding ability at the interface between the laminated skin member 4 and the resin base material 8 is increased by the resin that forms the resin base material 8 penetrating through the laminated skin member 4 at a time of the injection molding, however, the injection molded resin is prevented from excessively penetrating inside of the laminated skin member 4.

Further, according to the above-mentioned embodiment, the laminated skin member 4 is set in the cavity 106 of the injection mold 100 by being stretched in the arrow X direction in order to prevent the laminated skin member 4 from creasing. At this time, the elastic modulus of the laminated skin member 4 in the arrow X direction of the molded laminate 2 is set equal to or lower than 196N/25 mm with the laminated skin member 4 being stretched by 33%, as mentioned above. That is, the elastic modulus of the laminated skin member 4 before the injection molding being performed is set in a low range so that the laminated skin member 4 may have the flexibility before injection molded.

Within a range of the aforementioned elastic modulus of the laminated skin member 4 in the arrow X direction, the laminated skin member 4 has a required flexibility. Thus, the residual stress in the laminated skin member 4 in the molded laminate 2, which is formed by the laminated skin member 4 and the resin base material 8 being integrally molded, may be reduced. Even if the resin base material 8 of the molded laminate 2 becomes softened under the operating temperature, the molded laminate 2 is prevented from warping, thereby contributing to the high quality of the molded laminate 2.

According to the aforementioned embodiment, the molded laminate 2 is constituted to be prevented from warping in the arrow Y direction. As shown in FIG. 1, one side 21 of the molded laminate 2 is set longer than the other side 22. The other side 22 corresponds to the arrow X (vehicle longitudinal direction) while the one side 21 corresponds to the arrow Y (vehicle transverse direction). When the molded laminate 2 has a thin shape, the one side 21 of the molded laminate 2 tends to droop by its own weight since the one side 21 is longer than the other side 22. In order to avoid this situation, as shown in FIG. 3, a center portion 21c of the one side 21 is bent into an arched shape in section so that the center portion 21c is positioned on the upper side relative to an end portion 21e of the one side 21. The molded laminate 2 has the high rigidity structure by being reinforced with a thin domed structure of the one side 21. In addition, as shown in FIG. 1, the reinforcing ribs 2a and 2b formed on the molded laminate 2 extend along the arrow Y direction, thereby preventing the molded laminate 2 from warping in the arrow Y direction. Thus, the center portion 21c of the one side 21 of the molded laminate 2 is prevented from drooping by its own weight.

Further, according to the present embodiment, the elastic modulus of the laminated skin member 4 is set to have the anisotropy so that E2 is greater than E1. The elastic modulus E1 is set relatively lower at a time before the injection molding is performed. At the same time, the elastic modulus E2 is set relatively higher than E1 at a time before the injection molding is performed. Therefore, the rigidity in the extending direction of the one side 21 of the molded laminate 2 is set higher. The center portion 21c in the extending direction of the one side 21 is further prevented from drooping by its own weight. Even if the operating period of the molded laminate 2 for the sunshade 10 is longer or the operating temperature condition thereof is severe, the molded laminate 2 is further prevented from drooping, thereby contributing to the better appearance.

### TEST EXAMPLE

Test samples (No. 1 to No. 6) were tested based on the aforementioned embodiment. The table 1 shows the condition and the result of the test. The samples No. 1 to No. 3 are comparative examples. The elastic modulus of the sample No. 2 is substantially equal to the sample No. 3. However, the density of the foamed layer of the sample No. 2 is slightly different from that of the sample No. 3. The samples No. 4 to No. 6 each correspond to the present embodiment. As shown in the test samples No. 1 to No. 6, the evaluation of the performance of the molded laminate 2 against crushing was good when the density of the foamed layer 5 was 0.050 g/cm³, the density of the backing layer was 120 g/cm², and the elastic modulus of the laminated skin member 4 was equal to or smaller than 196N/25 mm (approximately 20 kgf/25 mm). Moreover, the evaluation of the performance of the molded laminate 2 against warping was good. The performance against crushing was evaluated visually after the injection molding. The performance against warping was evaluated in a state in which the sunshade was fit into a sunroof frame and left at 110 degrees in Celsius for 240 hours.

According to the above-mentioned test samples No. 4 to No. 6, the elastic modulus of the laminated skin member 4 is set equal to or smaller than 196N/25 mm. As shown in the pattern C1 in FIG. 8, thus, the laminated skin member 4 is cut from the roll member 9 such that the arrow X direction of the molded laminate 2 before the injection molding corresponds to the crosswise direction of the roll member 9. As a result, the elastic modulus E1 of the laminated skin member 4 was set relatively lower, thereby preventing the molded laminate 2 from warping in the X direction.

TABLE 1

| | Producing condition | | | | | | |
|---|---|---|---|---|---|---|---|
| | | | | | Cutting | | |
| | | | | Elastic | direction of | | |
| | | | | modulus | laminated | | |
| | | Density | Density | of lam- | skin | | |
| | | of | of | inated | member | Evaluation | |
| | skin | layer | layer | member | member (= X | Against | Against |
| No. | member | (g/cm3) | (g/m2) | (N/25 mm) | direction) | crusing | warping |
| 1 | Fabric | 0.030 | 120 | — | Lengthwise | Moderate | Moderate |
| 2 | Fabric | 0.050 | 120 | — | Lengthwise | Moderate | Moderate |
| 3 | Fabric | 0.050 | 120 | 235.2 | Lengthwise | Good | Moderate |
| 4 | Fabric | 0.050 | 120 | 83.3 | Crosswise | Good | Excellent |
| 5 | Fabric | 0.060 | 120 | 88.2 | Crosswise | Excellent | Excellent |
| 6 | Fabric | 0.060 | 140 | 127.4 | Crosswise | Excellent | Excellent |

Each thickness and material of the foamed layer 5, the decorative skin member 6, the backing layer 7, or the resin base material 8 may not be limited to the above and be varied depending on the purpose of the molded laminate 2, and the like. According to the above-mentioned embodiment, the laminated skin member 4 has the anisotropy in the elastic modulus. However, it may be acceptable for the laminated skin member 4 not to have the anisotropy in the elastic modulus.

According to the present embodiment, the molded laminate 2 is employed in the sunshade 10 used for the sunroof device 1. However, the molded laminate 2 is not limited to the sunshade 10 and may be applied to a molded laminate used for a portion whose temperature is raised by receiving the sunlight, infrared rays and the like. For example, the molded laminate 2 may be applied to the sunshade 10 for the sunroof device mounted on the building. Moreover, the molded laminate 2 may be applied to the interior equipment not receiving the sunlight, infrared rays or the like.

In addition, according to the present embodiment, the reinforcing ribs 2a and 2b extend along the one side 21 of the molded laminate 2. However, the reinforcing ribs 2a and 2b are not limited to extend in the above direction and may extend along the other side 22.

Further, according to the present embodiment, the molded laminate 2 has a rectangular shape with the longer side generally corresponding to the vehicle transverse direction and the shorter side generally corresponding to the vehicle longitudinal direction. However, the molded laminate 2 is not limited to have the above shape and may have the rectangular shape with the longer side corresponding to the vehicle longitudinal direction and the shorter side corresponding to the vehicle transverse direction, a square shape, substantially square shape, round shape, or substantially round shape.

Furthermore, according to the present embodiment, the inlets 110 are opened in order from the lower side to the upper side in FIG. 7 in the injection mold 100 and then the resin is input from the lower side to the upper side of the cavity 106. Alternatively, the inlets 110 are opened from the upper side to the lower side in the injection mold 100. However, the inlets 110 are not limited to be opened in the above-mentioned manner and may be opened at the same time.

The molded laminate according to the present invention may be employed in the interior equipment of the vehicle, building and the like, such as a sunshade, a ceiling wall and a door trim. The molded laminate is appropriate to be applied to a portion that receives the sunlight and infrared rays, such as the sunshade.

The molded laminate according to the present invention includes the sheet-shaped laminated skin member and the resin base material, which is integrally formed on the opposite side to the decorative face of the laminated skin member by the injection molding. When the molded laminate is used in a portion such as a sunshade, whose temperature is easy to be raised, a high heat-resisting material including the strengthened fiber such as the glass fiber is desired for the resin base material. The strengthened fiber, however, may not be necessarily included in the resin base material. The resin for the resin base material is required to be injection molded and the thermoplastic resin is generally employed. Considering the heat resistance and the like, polycarbonate (PC), acrylonitrile butadiene styrene (ABS), acrylonitrile-ethylene propylene-terpolymer-styrene (AES), polybutylene terephthalate (PBT), and the like may be employed for the resin base material. In addition, a plane shape of the molded laminate according to the present invention is not limited to a specific shape and may be a square, a substantially square, a rectangular shape, a substantially rectangular shape, a round shape, a substantially round shape, an elliptical shape, a substantially elliptical shape, and the like.

According to the present invention, before the laminated skin member and the resin base material are integrally molded, the elastic modulus of the laminated skin member in the warping deformation preventive direction is set equal to or smaller than 196N/25 mm (approximately 20 kgf/25 mm) with the laminated skin member being stretched by 33%. The laminated skin member has the flexibility in the warping deformation preventive direction before the infection molding, accordingly. The elastic modulus of the laminated skin member in the warping deformation preventive direction with the laminated skin member being stretched by 33% is desirably set equal to or smaller than 176N/25 mm (approximately 18 kgf/25 mm), or 147N/25 mm (approximately 15 kgf/25 mm), and also can be set equal to or smaller than 98N/25 mm (approximately 10 kgf/25 mm).

If the elastic modulus of the laminated skin member in the warping deformation preventive direction is set extremely small, the surface is easy to move at the resin molding, thereby causing the crease in the surface. Therefore, the lower limit of the elastic modulus of the laminated skin member in the warping deformation preventive direction is generally defined equal to or greater than 10N/25 mm, 20N/25 mm, or 40N/25 mm though it depends on the material and the injection molding pressure conditions, but not limited thereto.

According to the present invention, the density of the foamed layer constituting the laminated skin member is desirably set equal to or greater than 0.04 g/cm³, 0.045 g/cm³, or 0.05 g/cm³. Then, the foamed layer is prevented from being excessively crushed by the injection molding pressure when the resin base material is injection molded. Therefore, the better appearance of the molded laminate as well as the appropriate rigidity thereof may be ensured after the injection molding. If the density of the foamed layer is extremely high, the rigidity thereof is excessive. Then, the density of the foamed layer is defined equal to or smaller than 0.5 g/cm³, or 0.3 g/cm³. As the material of the foamed layer, the porous material such as urethane foam and polyethylene form in polyether series and polyester series is desired.

As the material for the decorative skin member, both fabric and nonwoven fabric are employed. The backing layer prevents the resin constituting the resin base material from excessively penetrating through the laminated skin member at the injection molding. Thus, the density of the backing layer is desirably set equal to or greater than 70 g/m². Then the resin of the resin base material is prevented from excessively penetrating through the laminated skin member at the injection molding. The density of the backing layer is set equal to or greater than 90 g/m², 100 g/m², 120 g/m², or 130 g/m² as required. If the density of the backing layer is excessively high, the elastic modulus of the laminated skin member, the product weight, and the cost are likely to be increased. Thus, the density of the backing layer is desirably set equal to or smaller than 400 g/m² or 300 g/m² though it depends on the material and the injection molding pressure conditions. As the material of the backing layer, polyester, nylon, rayon, and the like are defined. If the backing layer is made from the nonwoven fabric, the backing layer may be formed through spunbonding, needle punching, or water punching. The water punching may be the most desirable for increasing the density while decreasing the elastic modulus. The principles, preferred embodiment and mode of operation of the present invention have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A sheet-shaped molded laminate including at least one of a concave portion and a convex portion, comprising:
a laminated skin member including a sheet-shaped lamination structure and a decorative face; and
a resin base material integrally injection molded on a face of the laminated skin member placed on an opposite side to the decorative face of the laminated skin member;
the laminated skin member including a sheet-shaped foamed layer with a density equal to or greater than 0.04 g/cm³, a sheet-shaped decorative skin member bonded to one face of the foamed layer and including the decorative face, and a sheet-shaped backing layer bonded to the other face of the foamed layer; wherein before the laminated skin member and the resin base material are integrally molded, an elastic modulus of the laminated skin member in a warping deformation preventive direction of the molded laminate is equal to or smaller than 196N/25 mm (width of a test piece of the laminated skin member: 25 mm) with the laminated skin member being stretched by 33%.

2. A molded laminate according to claim 1, wherein the laminated skin member has an anisotropy in the elastic modulus thereof before the laminated skin member and the resin base material are integrally molded, and the elastic modulus of the laminated skin member in the warping deformation preventive direction of the molded laminate is set lower than an elastic modulus of the laminated skin member in a crossing direction to the warping deformation preventive direction.

3. A molded laminate according to claim 2, wherein a density of the backing layer is set equal to or greater than 100 g/m².

4. A molded laminate according to claim 3, wherein the molded laminate is used for an interior equipment.

5. A producing method of a molded laminate including at least one of a concave portion and a convex portion, comprising:
a first step for preparing a laminated skin member including a lamination structure formed by a sheet-shaped foamed layer, a sheet-shaped decorative skin member bonded to one face of the foamed layer and including a decorative face, and a sheet-shaped backing layer bonded to the other face of the foamed layer;
a second step for setting the laminated skin member in a cavity of an injection mold having a concave portion or a convex portion; and
a third step for molding a resin base material on the backing layer side of the laminated skin member by injection molding of a resin in the cavity and at the same time, integrally bonding the backing layer of the laminated skin member and the resin base material, wherein the foamed layer is set with a density equal to or greater than 0.04 g/cm³ in the first step and an elastic modulus of the laminated skin member in a warping deformation preventive direction of the molded lamination in the first step is set equal to or smaller than 196N/25 mm (width of a test piece of the laminated skin member: 25 mm) with the laminated skin member being stretched by 33%.

6. A producing method of a molded laminate according to claim 5, wherein in the first step, the laminated skin member has an anisotropy in the elastic modulus thereof, and the elastic modulus of the laminated skin member in the warping deformation preventive direction of the molded laminate is set lower than an elastic modulus of the laminated skin member in a crossing direction to the warping deformation preventive direction.

7. A producing method of a molded laminate according to claim 6, wherein in the first step, the laminated skin member is supplied from a roll member being wound into a roll shape, and set in the cavity in the second step such that the warping deformation preventive direction of the molded laminate corresponds to a crosswise direction of the roll member under a condition that a winding direction of the roll member is defined as a lengthwise direction thereof and a crossing direction to the winding direction of the roll member is defined as the crosswise direction thereof.

8. A molded laminate according to claim 3, wherein the density of the backing layer is between 100 g/m² and 160 g/m².

9. A molded laminate according to claim 5, wherein the density of the formed layer is between 0.057 g/m³ and 0.063 g/m³.

10. A molded laminate according to claim 5, wherein when the resin of the resin base material is injection molded on the backing layer side of the laminated skin member, the molded resin penetrates through the backing layer thereby forming a penetrating portion between the backing layer and the resin base material.

11. A molded laminate according to claim 6, wherein the molded laminate after injection molded is heated by infrared rays.
